(19) United States
(12) Patent Application Publication
(10) Pub. No.: US 2023/0246952 A1
(43) Pub. Date: Aug. 3, 2023

(54) SYSTEM, APPARATUS, AND METHOD FOR INTELLIGENT SIGNAL ROUTING IN AN INDUSTRIAL COMMUNICATION NETWORK

(71) Applicant: Siemens Aktiengesellschaft, München (DE)

(72) Inventor: Sankujyoti Neog, Bangaluru (IN)

(21) Appl. No.: 18/098,460

(22) Filed: Jan. 18, 2023

(30) Foreign Application Priority Data
Jan. 31, 2022 (EP) 22154267.3

(51) Int. Cl. H04L 45/28; H04L 67/12

(52) U.S. Cl. CPC H04L 45/28; H04L 67/12

(57) ABSTRACT

The present disclosure provides a system, apparatus, and method for intelligent signal routing in an industrial communication network. The system includes a connector device including a signal mixer configured to superimpose a at least one unique ID on at least one field signal to generate a mixed signal. The system further includes a field signal marshal device including a first input-output channel configured to transmit to a junction box device, a first request for a specific field signal associated with a specific unique ID. The junction box device includes a first processing unit configured to determine whether the specific unique ID matches with the at least one unique ID in the mixed signal. The first processing unit is further configured to route the mixed signal to the first input-output channel based on a determination that the specific unique ID matches with the at least one unique ID.

### CROSS-REFERENCE TO RELATED APPLICATIONS

This application claims priority to EP Application No.22154267.3, having a filing date of Jan. 31, 2022, the entire contents of which are hereby incorporated by reference.

### FIELD OF TECHNOLOGY

The following relates to a field of engineering of computer assisted engineering, and more particularly relates to a system, apparatus, and a method for intelligent signal routing in an industrial communication network.

### BACKGROUND

A technical installation comprises a plurality of field devices and a plurality of controllers which are communicatively coupled to each other via an industrial communication network. The technical installation is at least one of an industrial manufacturing plant, an industrial processing plant, or an industrial power plant. The plurality of field devices function together in the technical installation to achieve one or more objectives of the technical installation. Examples of the plurality of field devices comprises servers, robots, switches, automation devices, motors, valves, pumps, actuators, sensors and other industrial equipment(s). The plurality of controllers comprise programmable logic controllers (PLC)s, human machine interfaces (HMIs). Examples of the industrial communication network includes Ethernet, Modbus, Controlnet and the like.

The plurality of field devices and the plurality of controllers communicate with each other via a plurality of cables of the industrial communication network. The plurality of cables comprises ethernet cables, robotic cables, sensor cables, multicore cables, and the like. The plurality of cables are implemented via a cable engineering process. The cable engineering process includes a list of activities associated with cable scheduling, cable routing, and cable termination associated with the plurality of cables in the industrial communication network.

Typically, the technical installation comprises hundreds and thousands of field devices. It is a laboursome, time-consuming, and difficult task for a commission engineer to manually implement a plurality of cable-based communication channels between each of the plurality of field devices and the plurality of controllers. Further, a few cables of the plurality of cables may be faulty. Since faulty cables lead to unscheduled downtimes, the faulty cables have to be identified by human operators via regular performance of loop testing in the plurality of cables. It is a laboursome, time-consuming, and difficult task for the human operators to manually perform loop testing for each of the plurality of cables. Furthermore, in a case where the faulty cables are identified in the plurality of cables, it is difficult to replace the faulty cables with functioning cables without requiring extensive downtime. Furthermore, often, the plurality of cables are not terminated correctly by the commission engineer. Incorrect termination of the plurality of cables lead to unscheduled downtimes.

### SUMMARY

An aspect relates to provide a system, apparatus, and method for intelligent signal routing in an industrial communication network.

The aspect is achieved by a system for intelligent signal routing in an industrial communication network. The industrial communication network interconnects a plurality of field devices and a plurality of controllers in a technical installation. The technical installation is at least one of an industrial manufacturing plant, an industrial processing plant, or an industrial power plant. The plurality of field devices function together in the technical installation to achieve one or more objectives of the technical installation. Examples of the plurality of field devices comprises servers, robots, switches, automation devices, motors, valves, pumps, actuators, sensors and other industrial equipment(s). The plurality of controllers comprise programmable logic controllers (PLC)s, human machine interfaces (HMIs). Examples of the industrial communication network includes Ethernet, Modbus, Controlnet and the like. The plurality of field devices and the plurality of controllers communicate with each other via a plurality of cables of the industrial communication network.

The plurality of cables comprises ethernet cables, robotic cables, sensor cables, multicore cables, and the like. In one example, each of the plurality of cables is a multicore cable. The system comprises a connector device, a field signal marshal device, and a junction box device. The connector device is a device which is configured to carry field signals between a field device and the field signal marshal device. The field signal marshal device is a device which is configured to carry field signals from the connector device to the junction box device. The junction box device is configured to transmit the field signals to a programmable logic controller. The connector device is communicatively coupled with at least one field device of the plurality of field devices, via at least one cable of the plurality of cables. The at least one field device has at least one unique identification number (ID). The unique identification number is at least one an alphanumeric, hexadecimal, or a binary code to identify the at least one field device. Each of the plurality of field devices have one or more unique Ids. The at least one field device is configured to generate at least one field signal. The connector device receives the at least one field signal via the at least one cable connected to the at least one field device. The connector device is further communicatively coupled to the junction box device. The connector device is a device which is configured to receive, process and transmit the at least one field signal to the junction box device.

The connector device comprises a signal mixer. The signal mixer is at least one of an active mixer and a passive mixer. The signal mixer is at least one of a balanced mixer and an unbalanced mixer. The signal mixer is configured to receive the at least one field signal from the at least one field device. The signal mixer is further configured to superimpose the at least one unique ID on the received at least one field signal to generate a mixed signal. In one example, the signal mixer superimposes the at least one unique ID on the at least one field signal by superimposing a high frequency signal on the at least one field signal. In such a case, the high frequency signal comprises information associated with the at least one unique ID.

In the preferred embodiment, the field signal marshal device is communicatively coupled to an input-output module and the junction box device. The input output module is connected to one or more of the plurality of controllers. The one or more of the plurality of controllers generate a first request for a specific field signal from a specific field device of the plurality of field devices. The first request comprises information about a specific unique ID associated with the specific field device. The field signal marshal device is configured to receive the first request from the input-output module. Further, the field signal marshal device is configured to receive the mixed signal generated by the signal mixer, via the junction box device. The field signal marshal device is connected to the junction box device via one or more of the plurality of cables.

In the preferred embodiment, the field signal marshal device further comprises a first input-output channel. In one example, the first input-output channel is connected to the plurality of cables, on one end and is connected to the input-output module on the other end. The first input-output channel is configured to transmit to the junction box device, the first request comprising the specific unique ID associated with the specific field signal. The first input-output channel is further configured to transmit the mixed signal to the input-output module.

In the preferred embodiment, the junction box device is connected to the connector device and the field signal marshal device. The junction box device comprises a first processing unit. The first processing unit, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The first processing unit may also include embedded controllers, such as generic or programmable logic devices or arrays, application specific integrated circuits, single-chip computers, and the like. The first processing unit is configured to receive, the first request from the field signal marshal device and the mixed signal from the signal mixer.

In the preferred embodiment, the first processing unit is further configured to extract, from the mixed signal, the at least one unique ID of the at least one field device. The first processing unit is further configured to compare the specific unique ID in the first request, with the at least one unique ID extracted from the mixed signal. The first processing unit is further configured to determine whether the specific unique ID matches with the at least one unique ID in the mixed signal. The first processing unit is further configured to route the mixed signal associated with the at least one unique ID, to the first input-output channel based on a determination that the specific unique ID matches with the at least one unique ID. Advantageously, the system intelligently routes the at least one field signal to the first input-output channel, based on the first request received from the input-output module. Thus, the at least one field signal is routed to the plurality of controllers automatically, without user intervention. Furthermore, time and effort required to perform cable engineering and hardwiring the plurality of field devices to the plurality of controllers is reduced. Furthermore, the system enables the commission engineer to reroute the at least one field devices to different controllers of the plurality of controllers, without making hardware changes

In the preferred embodiment, the system further comprises a memory. The memory may be non-transitory volatile memory and non-volatile memory. The memory may be coupled for communication with the first processing unit, such as being a computer-readable storage medium. The first processing unit may execute machine-readable instructions and/or source code stored in the memory. A variety of machine-readable instructions may be stored in and accessed from the memory 204. The memory may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory includes an integrated development environment (IDE). The IDE includes an automation module stored in the form of machine-readable instructions on any of the above-mentioned storage media and may be in communication with and executed by the first processing unit. The memory is further configured to store a look-up table. The look-up table comprises information associated with a plurality of mappings between a plurality of unique IDs and a plurality of input-output channels of the field signal marshal device associated with a plurality of field devices connected to the industrial communication network. The plurality of mappings in the look-up table denotes correct mapping of the plurality of field devices to the plurality of input-output channels.

In the preferred embodiment, the first processing unit is further configured to capture a signal from an active communication channel between a field device of the plurality of field devices and a second input-output channel of the plurality of input-output channels. In one example, the captured signal is the mixed signal generated by the signal mixer of the connector device.

In the preferred embodiment, the first processing unit is further configured to extract a unique ID from the signal captured from the active communication channel. In one example, the first processing unit is configured to extract the unique ID by application of at least one signal processing filter on the captured signal. Examples of the at least one signal processing filter include a high-pass filter and a low-pass filter. In another example, the first processing unit is configured to extract the unique ID by application of a decryption algorithm on the captured signal.

In the preferred embodiment, the first processing unit is further configured to compare the extracted unique ID with each of the plurality of unique ID present in the look-up table. In a case where the extracted unique ID is present in the look-up table, the first processing unit is configured to determine whether the extracted unique ID is mapped to the second input-output channel of the plurality of input-output channels. In a case where it is determined that, in the look-up table, the extracted unique ID is not mapped to the second input-output channel, the first processing unit is further configured to terminate the active communication channel. Advantageously, any active communication channel from incorrectly connected field devices of the plurality of field devices are automatically terminated. Thus, the plurality of field devices are protected from incorrect termination.

Further, the first processing unit is further configured to analyze the look-up table to determine whether a third input-output channel of the plurality of input-output channels which is mapped to the extracted unique ID. The first processing unit is further configured to reroute the captured signal to the determined third input-output channel of the plurality of input-output channels. Advantageously, any faults in connections between the plurality of field devices and the plurality of input-output channels are automatically rectified. Thus, the plurality of field devices are protected from incorrect termination.

In a preferred embodiment, the field signal marshal device further comprises a second processing unit. The second processing unit may be similar in structure and functionality as the first processing unit. The second processing unit is configured to transmit a second request to the junction box device via the first input-output channel. The second request is to conduct a loop test of the first input-output channel. The second processing unit is further configured to determine whether the field signal marshal device receives a response for the second request from the junction box device, within a specified time interval, via the first input-output channel.

The second processing unit is further configured to display, based on a determination that the response is not received within the specific time interval, a notification that the first input-output channel is faulty. The notification is displayed on a display device. The second processing unit is further configured to transmit the second request for the loop test to the junction box device via the second input-output channel of the plurality of input-output channels.

In a preferred embodiment, the connector device further comprises a third processing unit which is configured to extract, from the look-up table, the at least one unique ID associated with the at least one field device. The third processing unit is further configured to generate the high frequency signal based on the extracted at least one unique ID.

The aspect is achieved by an apparatus for intelligent signal routing in an industrial communication network. The apparatus for intelligent signal routing in an industrial communication network comprises a signal mixer, a first processing unit, and a first input-output channel. The signal mixer is further configured to receive at least one field signal from the at least one field device. The at least one field device has at least one unique ID. The signal mixer is further configured to superimpose the at least one unique ID on the received at least one field signal to generate a mixed signal.

The first input-output channel is configured to transmit to the signal mixer, a first request comprising a specific unique ID associated with a specific field signal. The first input-output channel is configured to transmit the mixed signal to an input-output module. The first processing unit is configured to receive, the first request from the first input-output channel and the mixed signal from the signal mixer.

The first processing unit is further configured to extract the at least one unique ID from the mixed signal. The first processing unit is further configured to determine whether the specific unique ID matches with the at least one unique ID associated with the at least one field device. The first processing unit is further configured to route the mixed signal associated with the at least one unique ID, to the first input-output channel based on a determination that the specific unique ID matches with the at least one unique ID associated with the at least one field device.

In a preferred embodiment, the apparatus further comprises a memory which is configured to store a look-up table. The look-up table comprises information associated with mappings between a plurality of unique IDs associated with a plurality of field devices in the industrial communication network, and a plurality of input-output channels of the field signal marshal device.

In the preferred embodiment, the first processing unit is further configured to capture a signal from an active communication channel between a field device of the plurality of field devices and a second input-output channel of the plurality of input-output channels. The first processing unit is further configured to extract a unique ID from the signal captured from the active communication channel. The first processing unit is further configured to analyze the look-up table to determine whether, in the look-up table, the extracted unique ID is mapped to the second input-output channel of the plurality of input-output channels. The first processing unit is further configured to terminate the active communication channel based on a determination that the extracted unique ID is not mapped to the second input-output channel of the plurality of input-output channels.

In the preferred embodiment, the first processing unit is further configured to analyze the look-up table to determine a third input-output channel of the plurality of input-output channels, into which the extracted unique ID is mapped. The first processing unit is further configured to reroute the captured signal to the determined third input-output channel of the plurality of input-output channels.

In the preferred embodiment, the apparatus further comprising a second input-output channel and a second processing unit. The second processing unit is configured to transmit a second request to the junction box device via the first input-output channel. The second request is for conducting a loop test of the first input-output channel. The second processing unit is further configured to determine whether the field signal marshal device receives a response for the second request from the junction box device, within a specified time interval, via the first input-output channel. The second processing unit is further configured to display, based on a determination that the response is not received within the specific time interval, a notification that the first input-output channel is faulty. The second processing unit is further configured to transmit the second request for the loop test to the junction box device via the second input-output channel.

In the preferred embodiment, the apparatus further comprises a third processing unit configured to extract, from the look-up table, the at least one unique ID associated with the at least one field device. The third processing unit is further configured to generate the high frequency signal based on the extracted at least one unique ID, wherein the at least one unique ID is superimposed on the at least one field signal by mixing the high frequency signal with the at least one field signal.

The aspect is further achieved by a method for intelligent signal routing in an industrial communication network. The method of intelligent signal routing in an industrial communication network is executed in a system comprising a signal mixer, a first input-output channel, and a first processing unit.

In the preferred embodiment, the method comprises receiving, by the signal mixer, at least one field signal from the at least one field device. The at least one field device has at least one unique ID. The method further comprises superimposing, by the signal mixer, the at least one unique ID on the received at least one field signal to generate a mixed signal. The method further comprises transmitting via the first input-output channel to a junction box device, a first request comprising a specific unique ID associated with a specific field signal. The method further comprises extracting, by the first processing unit, the at least one unique ID from the mixed signal. The method further comprises determining, by the first processing unit, whether the specific unique ID matches with the at least one unique ID associated with the at least one field device. The method further comprises routing, by the first processing unit, the mixed signal associated with the at least one unique ID, to the first input-output channel based on a determination that the specific unique ID matches with the at least one unique ID associated with the at least one field device.

In the preferred embodiment, the method further comprises capturing, by the first processing unit, a signal from an active communication channel between a field device of a plurality of field devices and a second input-output channel of a plurality of input-output channels. The method further comprises extracting, by the first processing unit, a unique ID from the signal captured from the active communication channel.

The method further comprises analyzing, by the first processing unit, a look-up table to determine whether, in the look-up table, the extracted unique ID is mapped to the second input-output channel of the plurality of input-output channels. The method further comprises terminating, by the first processing unit, the active communication channel based on a determination that the extracted unique ID is not mapped to the second input-output channel of the plurality of input-output channels.

In the preferred embodiment, the method further comprises analyzing, by the first processing unit, the look-up table to determine a third input-output channel of the plurality of input-output channels, into which the extracted unique ID is mapped. The method further comprises rerouting, by the first processing unit, the captured signal to the determined third input-output channel of the plurality of input-output channels.

In the preferred embodiment, the method further comprises transmitting, by the first processing unit, a second request to the junction box device via the first input-output channel. The second request is for conducting a loop test of the first input-output channel. The method further comprises determining, by the first processing unit, whether the field signal marshal device receives a response for the second request from the junction box device, within a specified time interval, via the first input-output channel.

The method further comprises displaying, by the first processing unit, based on a determination that the response is not received within the specific time interval, a notification that the first input-output channel is faulty. The method further comprises transmitting, by the first processing unit, the second request for the loop test to the junction box device via the second input-output channel.

In the preferred embodiment, the method further comprises extracting, by the first processing unit, from the look-up table, the at least one unique ID associated with the at least one field device. The method further comprises generating, by the first processing unit, the high frequency signal based on the extracted at least one unique ID, wherein the at least one unique ID is superimposed on the at least one field signal by mixing the high frequency signal with the at least one field signal.

The above-mentioned and other features of embodiments of the invention will now be addressed with reference to the accompanying drawings of the present disclosure. The illustrated embodiments are intended to illustrate, but not limit embodiments of the invention.

### BRIEF DESCRIPTION

Some of the embodiments will be described in detail, with reference to the following figures, wherein like designations denote like members, wherein:

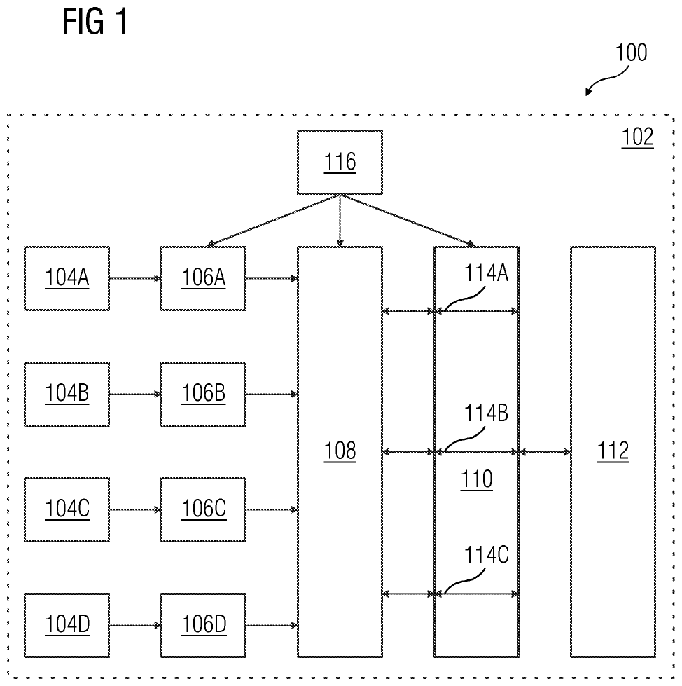

FIG. 1 is a block diagram of an system for intelligent signal routing in an industrial communication network, according to an embodiment of the present disclosure;

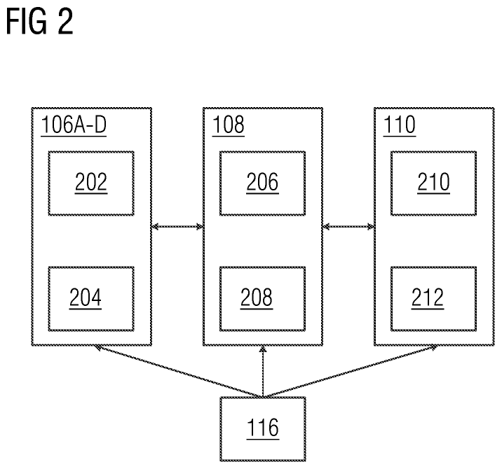

FIG. 2 is a block diagram of the system, such as that shown in FIG. 1, in which an embodiment of the present disclosure can be implemented;

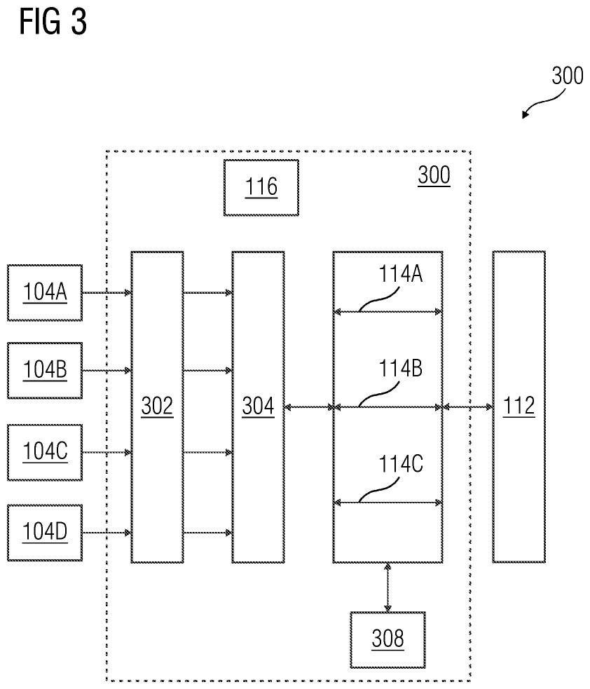

FIG. 3 is a block diagram of an apparatus for intelligent signal routing in an industrial communication network, in which an embodiment of the present disclosure can be implemented; and

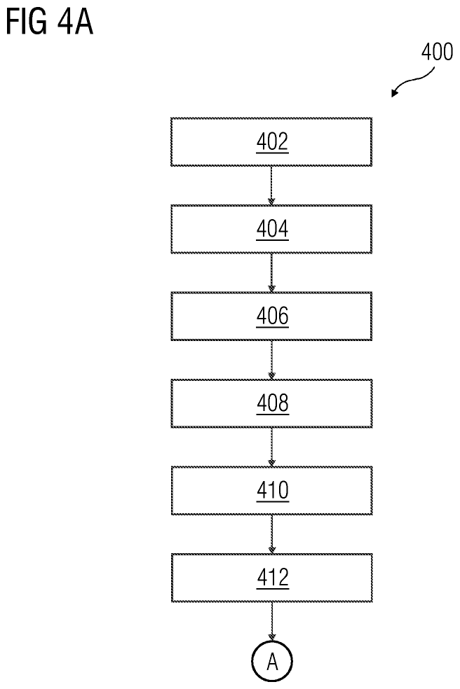

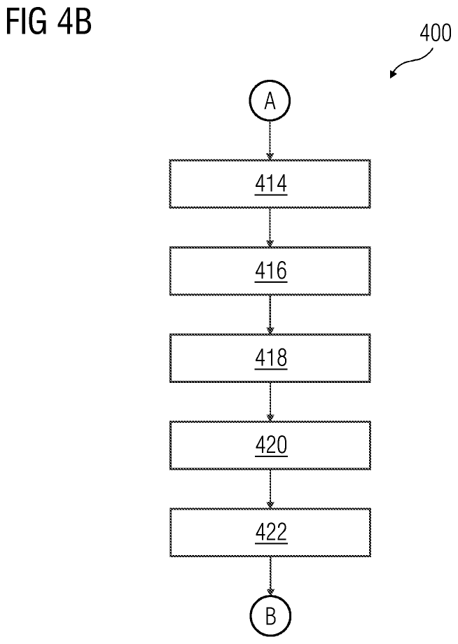

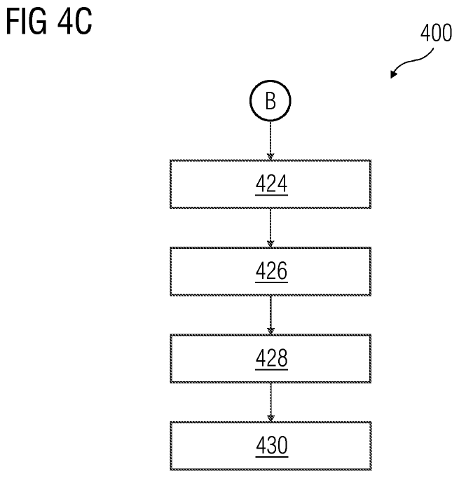

FIG. 4A is a flowchart of an method for intelligent signal routing in an industrial communication network, in which an embodiment of the present disclosure can be implemented;

FIG. 4B is a flowchart of the method for intelligent signal routing in an industrial communication network, in which an embodiment of the present disclosure can be implemented; and

FIG. 4C is a flowchart of the method for intelligent signal routing in an industrial communication network, in which an embodiment of the present disclosure can be implemented.

### DETAILED DESCRIPTION

Various embodiments are described with reference to the drawings, wherein like reference numerals are used to refer the drawings, wherein like reference numerals are used to refer to like elements throughout. In the following description, for the purpose of explanation, numerous specific details are set forth in order to provide thorough understanding of one or more embodiments. It may be evident that such embodiments may be practiced without these specific details.

FIG. 1 is a block diagram of a system 102 for intelligent signal routing in an industrial communication network 100, according to an embodiment of the present disclosure. The industrial communication network 100 interconnects a plurality of field devices 104AD and an input-output module 112 of a plurality of controllers in a technical installation.

The technical installation is at least one of an industrial manufacturing plant, an industrial processing plant, or an industrial power plant. The plurality of field devices 104AD function together in the technical installation to achieve one or more objectives of the technical installation. Examples of the plurality of field devices 104A-D comprises servers, robots, switches, automation devices, motors, valves, pumps, actuators, sensors and other industrial equipment(s). The plurality of controllers comprise programmable logic controllers (PLC)s, human machine interfaces (HMIs). Examples of the industrial communication network 100 includes Ethernet, Modbus, Controlnet and the like. The plurality of field devices 104A-D and the plurality of controllers communicate with each other via a plurality of cables of the industrial communication network 100.

The plurality of cables comprises ethernet cables, robotic cables, sensor cables, multicore cables, and the like. In one example, each of the plurality of cables is a multicore cable. The system 102 comprises at least one connector device 106A-D, a field signal marshal device 110, and a junction box device 108. The connector device 106A-D is communicatively coupled with at least one field device of the plurality of field devices 104AD, via at least one cable of the plurality of cables. The at least one field device has at least one unique identification number (ID). The unique identification number is at least one an alphanumeric, hexadecimal, or a binary code to identify the at least one field device. Each of the plurality of field devices 104A-D have one or more unique Ids. The at least one field device is configured to generate at least one field signal. The connector device 106A-D receives the at least one field signal via the at least one cable connected to the at least one field device. The connector device 106A-D is further communicatively coupled to the junction box device 108. The connector device 106A-D is a device which is configured to receive, process and transmit the at least one field signal to the junction box device 108. The field signal marshal device 110 is communicatively coupled to the input output module 112 and the junction box device 108. The input output module 112 is connected to one or more of the plurality of controllers. The one or more of the plurality of controllers generate a first request for a specific field signal from a specific field device of the plurality of field devices 104A-D. The system 102 further comprises a memory 116. The memory 116 may be non-transitory volatile memory and non-volatile memory.

FIG. 2 is a block diagram of the system, such as that shown in FIG. 1, in which an embodiment of the present disclosure can be implemented. FIG. 2 is explained in conjunction with elements of FIG. 1.

The connector device 106A-D comprises a signal mixer 202. The signal mixer 202 is at least one of an active mixer, a passive mixer, a balanced mixer or an unbalanced mixer. The signal mixer 202 is configured to receive the at least one field signal from at least one field device (104A, 104B, 104C, or 104D) of the plurality of field devices (104AD). The signal mixer 202 is further configured to superimpose the at least one unique ID on the received at least one field signal to generate a mixed signal. In one example, the signal mixer 202 superimposes the at least one unique ID on the at least one field signal by superimposing a high frequency signal on the at least one field signal. In such a case, the high frequency signal comprises information associated with the at least one unique ID.

The first request comprises information about a specific unique ID associated with the specific field device. The field signal marshal device 110 is configured to receive the first request from the input-output module 112. Further, the field signal marshal device 110 is configured to receive the mixed signal generated by the signal mixer 202, via the junction box device 108. The field signal marshal device 110 is connected to the junction box device 108 via one or more of the plurality of cables.

The field signal marshal device 110 further comprises a first input-output channel 114A of a plurality of input-output channels 114A-C. In one example, the first input-output channel 114A is connected to the plurality of cables, on one end and is connected to the input-output module 112 on the other end. The first input-output channel 114A is configured to transmit to the junction box device 108, the first request comprising the specific unique ID associated with the specific field signal. The first input-output channel 114A is further configured to transmit the mixed signal to the input-output module 112.

The junction box device 108 is connected to the connector device 106A-D and the field signal marshal device 110. The junction box device 108 comprises a first processing unit 206. The first processing unit 206, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The first processing unit 206 may also include embedded controllers, such as generic or programmable logic devices or arrays, application specific integrated circuits, single-chip computers, and the like. The first processing unit 206 is configured to receive, the first request from the field signal marshal device 110 and the mixed signal from the signal mixer 202.

The first processing unit 206 is further configured to extract, from the mixed signal, the at least one unique ID of the at least one field device 104A. The first processing unit 206 is further configured to compare the specific unique ID in the first request, with the at least one unique ID extracted from the mixed signal. The first processing unit 206 is further configured to determine whether the specific unique ID matches with the at least one unique ID in the mixed signal. The first processing unit 206 is further configured to route the mixed signal associated with the at least one unique ID, to the first input-output channel 114A based on a determination that the specific unique ID matches with the at least one unique ID. Advantageously, the system intelligently routes the at least one field signal to the first input-output channel 114A, based on the first request received from the input-output module. Thus, the at least one field signal is routed to the plurality of controllers automatically, without user intervention. Furthermore, time and effort required to perform cable engineering and hardwiring the plurality of field devices 104A-D to the plurality of controllers is reduced.

In one example, the junction box device 108 further comprises a demultiplexer 208. In such a case, the processing unit 206 is configured to route the mixed signal by using the demultiplexer 208.

The memory may be coupled for communication with the first processing unit 206, such as being a computer-readable storage medium. The first processing unit 206 may execute machine-readable instructions and/or source code stored in the memory. A variety of machine-readable instructions may be stored in and accessed from the memory 116. The memory may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory includes an integrated development environment (IDE). The IDE includes an automation module stored in the form of machine-readable instructions on any of the above-mentioned storage media and may be in communication with and executed by the first processing unit 206. The memory is further configured to store a look-up table. The look-up table comprises information associated with a plurality of mappings between a plurality of unique IDs and the plurality of input-output channels 114A-C of the field signal marshal device 110 associated with the plurality of field devices 104A-D connected to the industrial communication network 100. The plurality of mappings in the look-up table denotes correct mapping of the plurality of field devices 104A-D to the plurality of input-output channels 114A-C.

The first processing unit 206 is further configured to capture a signal from an active communication channel between a field device (such as the first field device 104A) of the plurality of field devices 104A-D and a second input-output channel 114B of the plurality of input-output channels 114A-D. In one example, the captured signal is the mixed signal generated by the signal mixer 202 of the connector device 106A-D.

The first processing unit 206 is further configured to extract a unique ID from the signal captured from the active communication channel. In one example, the first processing unit 206 is configured to extract the unique ID by application of at least one signal processing filter on the captured signal. Examples of the at least one signal processing filter include a high-pass filter and a low-pass filter. In another example, the first processing unit 206 is configured to extract the unique ID by application of a decryption algorithm on the captured signal.

The first processing unit 206 is further configured to compare the extracted unique ID with each of the plurality of unique ID present in the look-up table. In a case where the extracted unique ID is present in the look-up table, the first processing unit 206 is configured to determine whether the extracted unique ID is mapped to the second input-output channel 114B of the plurality of input-output channels 114A-C. In a case where it is determined that, in the look-up table, the extracted unique ID is not mapped to the second input-output channel 114B, the first processing unit 202 is further configured to terminate the active communication channel. Advantageously, any active communication channel from incorrectly connected field devices of the plurality of field devices 104A-D are automatically terminated. Thus, the plurality of field devices 104A-D are protected from incorrect termination. Furthermore, the system 102 enables the commission engineer to reroute the at least one field signal to different controllers by simply modifying the look-up table.

Further, the first processing unit 206 is further configured to analyze the look-up table to determine whether a third input-output channel 114C of the plurality of input-output channels 114A-C which is mapped to the extracted unique ID. The first processing unit 206 is further configured to reroute the captured signal to the determined third input-output channel 114C of the plurality of input-output channels 114A-C. Advantageously, any faults in connections between the plurality of field devices 104A-D and the plurality of input-output channels 114A-C are automatically rectified. Thus, the plurality of field devices 104A-D are protected from incorrect termination.

The field signal marshal device 110 further comprises a second processing unit 210. The second processing unit 210 may be similar in structure and functionality as the first processing unit 206. The second processing unit 210 is configured to transmit a second request to the junction box device via the first input-output channel 114A. The second request is to conduct a loop test of the first input-output channel 114A. The second processing unit 210 is further configured to determine whether the field signal marshal device 110 receives a response for the second request from the junction box device 108, within a specified time interval, via the first input-output channel 114A.

The second processing unit 210 is further configured to display, based on a determination that the response is not received within the specific time interval, a notification that the first input-output channel 114A is faulty. The notification is displayed on a display device 212. In one example, the display device is a liquid crystal display device. The second processing unit 210 is further configured to transmit the second request for the loop test to the junction box device 108 via the second input-output channel 114B of the plurality of input-output channels 114A-C.

The connector device 106A-D further comprises a third processing unit 204 which is configured to extract, from the look-up table, the at least one unique ID associated with the at least one field device. The third processing unit 204 is further configured to generate the high frequency signal based on the extracted at least one unique ID.

FIG. 3 is a block diagram of an apparatus 300 for intelligent signal routing in an industrial communication network 100, in which an embodiment of the present disclosure can be implemented.

The apparatus 300 for intelligent signal routing in the industrial communication network 100 comprises a signal mixer 302, a processing unit 304, and a plurality of input-output channels 114A-C. The signal mixer 302 is further configured to receive at least one field signal from at least one field device 104A of the plurality of field devices 104A-D. The at least one field device has at least one unique ID. The signal mixer 302 is further configured to superimpose the at least one unique ID on the received at least one field signal to generate a mixed signal.

A first input-output channel 114A is configured to transmit to the signal mixer 302, a first request comprising a specific unique ID associated with a specific field signal. The first input-output channel is further configured to transmit the mixed signal to the input-output module 112. The first processing unit 304 is configured to receive, the first request from the first input-output channel 114A and the mixed signal from the signal mixer 302.

The first processing unit 304 is further configured to extract the at least one unique ID from the mixed signal. The first processing unit 304 is further configured to determine whether the specific unique ID matches with the at least one unique ID associated with the at least one field device 104A. The first processing unit 304 is further configured to route the mixed signal associated with the at least one unique ID, to the first input-output channel 114A based on a determination that the specific unique ID matches with the at least one unique ID associated with the at least one field device 104A.

The apparatus 300 further comprises the memory 116 which is configured to store a look-up table. The look-up table comprises information associated with mappings between a plurality of unique IDs associated with the plurality of field devices 104A-D in the industrial communication network 100, and the plurality of input-output channels 114A-C.

The first processing unit 304 is further configured to capture a signal from an active communication channel between a field device 104A of the plurality of field devices 104A-D and a second input-output channel 114B of the plurality of input-output channels 114A-C. The first processing unit 304 is further configured to extract a unique ID from the signal captured from the active communication channel. The first processing unit 304 is further configured to analyze the look-up table to determine whether, in the look-up table, the extracted unique ID is mapped to the second input-output channel 114B of the plurality of input-output channels 114A-C. The first processing unit 304 is further configured to terminate the active communication channel based on a determination that the extracted unique ID is not mapped to the second input-output channel 114B of the plurality of input-output channels 114A-C.

The first processing unit 304 is further configured to analyze the look-up table to determine a third input-output channel 114C of the plurality of input-output channels 114A-C, into which the extracted unique ID is mapped. The first processing unit 304 is further configured to reroute the captured signal to the determined third input-output channel 114C of the plurality of input-output channels 114A-C.

The apparatus 300 further comprises a second processing unit 308 which is further configured to transmit a second request to the first input-output channel 114A for conducting a loop test of the first input-output channel 114A. The second processing unit 308 is further configured to determine whether the first input-output channel receives a response from the first processing unit 304, within a specified time interval. The second processing unit 308 is further configured to display, based on a determination that the response is not received within the specific time interval, a notification that the first input-output channel 114A is faulty. The second processing unit 308 is further configured to transmit the second request for the loop test to the first processing unit 304 via the second input-output channel 114B.

The first processing unit 304 is further configured to extract, from the look-up table, the at least one unique ID associated with the at least one field device. The third processing unit is further configured to generate the high frequency signal based on the extracted at least one unique ID, wherein the at least one unique ID is superimposed on the at least one field signal by mixing the high frequency signal with the at least one field signal.

FIG. 4A-D is a flowchart of an method 400 for intelligent signal routing in an industrial communication network 100, in which an embodiment of the present disclosure can be implemented. FIG. 4A-D is explained in conjunction with FIGS. 1, 2, and 3.

At step 402, the signal mixer 202 receives the at least one field signal from at least one field device (104A, 104B, 104C, or 104D) of the plurality of field devices (104A-D). At step 404, the signal mixer 202 superimposes the at least one unique ID on the received at least one field signal to generate a mixed signal. In one example, the signal mixer 202 superimposes the at least one unique ID on the at least one field signal by superimposing a high frequency signal on the at least one field signal. The high frequency signal is one of a analog or a digital signal which is superposed on the at least one field signal. In such a case, the high frequency signal comprises information associated with the at least one unique ID.

The first request comprises information about a specific unique ID associated with the specific field device. At step 406, the field signal marshal device 110 receives the first request from the input-output module 112. At step 408, field signal marshal device 110 receives the mixed signal generated by the signal mixer 202, via the junction box device 108. The field signal marshal device 110 is connected to the junction box device 108 via one or more of the plurality of cables.

At step 410, the first input-output channel 114A transmits to the junction box device 108, the first request comprising the specific unique ID associated with the specific field signal. At step 412, the first input-output channel 114A transmits the mixed signal to the input-output module 112.

The junction box device 108 is connected to the connector device 106A-D and the field signal marshal device 110. The junction box device 108 comprises a first processing unit 206. At step 414, the first processing unit 206 receives the first request from the field signal marshal device 110 and the mixed signal from the signal mixer 202.

At step 412, the first processing unit 206 extracts from the mixed signal, the at least one unique ID of the at least one field device 104A. The first processing unit 206 is further configured to compare the specific unique ID in the first request, with the at least one unique ID extracted from the mixed signal. At 414, the first processing unit 206 determines whether the specific unique ID matches with the at least one unique ID in the mixed signal. At 416, the first processing unit 206 routes the mixed signal associated with the at least one unique ID, to the first input-output channel 114A based on a determination that the specific unique ID matches with the at least one unique ID. Advantageously, the system 102 intelligently routes the at least one field signal to the first input-output channel 114A, based on the first request received from the input-output module. Thus, the at least one field signal is routed to the plurality of controllers automatically, without user intervention. Furthermore, time and effort required to perform cable engineering and hardwiring the plurality of field devices 104A-D to the plurality of controllers is reduced.

At 416, the first processing unit 206 captures a signal from an active communication channel between a field device (such as the first field device 104A) of the plurality of field devices 104A-D and a second input-output channel 114B of the plurality of input-output channels 114A-D. In one example, the captured signal is the mixed signal generated by the signal mixer 202 of the connector device 106A-D.

At 418, the first processing unit 206 extracts a unique ID from the signal captured from the active communication channel. In one example, the first processing unit 206 is configured to extract the unique ID by application of at least one signal processing filter on the captured signal. Examples of the at least one signal processing filter include a highpass filter and a low-pass filter. In another example, the first processing unit 206 is configured to extract the unique ID by application of a decryption algorithm on the captured signal.

At 420, the first processing unit 206 compares the extracted unique ID with each of the plurality of unique ID present in the look-up table. In a case where the extracted unique ID is present in the look-up table, the first processing unit 206 is configured to determine whether the extracted unique ID is mapped to the second input-output channel 114B of the plurality of input-output channels 114A-C. In a case where it is determined that, in the look-up table, the extracted unique ID is not mapped to the second input-output channel 114B, the first processing unit 202 is further configured to terminate the active communication channel. Advantageously, any active communication channel from incorrectly connected field devices of the plurality of field devices 104A-D are automatically terminated. Thus, the plurality of field devices 104A-D are protected from incorrect termination. Furthermore, the system 102 enables the commission engineer to reroute the at least one field signal to different controllers by simply modifying the look-up table.

At 422, the first processing unit 206 analyzes the look-up table to determine whether the third input-output channel 114C of the plurality of input-output channels 114A-C is mapped to the extracted unique ID. At 424, the first processing unit 206 reroutes the captured signal to the determined third input-output channel 114C of the plurality of input-output channels 114A-C. Advantageously, any faults in connections between the plurality of field devices 104A-D and the plurality of input-output channels 114A-C are automatically rectified. Thus, the plurality of field devices 104A-D are protected from incorrect termination.

At step 426, the second processing unit 210 transmits a second request to the junction box device 108 via the first input-output channel 114A. The second request is to conduct a loop test of the first input-output channel 114A. The second processing unit 210 is further configured to determine whether the field signal marshal device 110 receives a response for the second request from the junction box device 108, within a specified time interval, via the first input-output channel 114A.

At step 428, the second processing unit 210 displays, based on a determination that the response is not received within the specific time interval, a notification that the first input-output channel 114A is faulty. The notification is displayed on the display device 212. The second processing unit 210 is further configured to transmit the second request for the loop test to the junction box device 108 via the second input-output channel 114B of the plurality of input-output channels 114A-C.

At step 430, the third processing unit 204 extracts, from the look-up table, the at least one unique ID associated with the at least one field device. The third processing unit 204 is further configured to generate the high frequency signal based on the extracted at least one unique ID.

The present disclosure can take a form of a computer program product (non-transitory computer readable storage medium having instructions, which when executed by a processor, perform actions) comprising program modules accessible from computer-usable or computer-readable medium storing program code for use by or in connection with one or more computers, processors, or instruction execution system. For the purpose of this description, a computer-usable or computer-readable medium can be any apparatus that can contain, store, communicate, propagate, or transport the program for use by or in connection with the instruction execution system, apparatus, or device. The medium can be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processors and program code for implementing each aspect of the technology can be centralized or distributed (or a combination thereof) as known to those skilled in the art.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A system for intelligent signal routing in an industrial communication network, the system comprising:
a connector device comprising a signal mixer, wherein the signal mixer is configured to:
receive at least one field signal from the at least one field device, wherein the at least one field device has at least one unique identification number (ID); and
superimpose the at least one unique ID on the received at least one field signal to generate a mixed signal;
a field signal marshal device comprising a first input-output channel, wherein the first input-output channel is configured to:
transmit to a junction box device, a first request comprising a specific unique ID associated with a specific field signal; and
transmit the mixed signal to an input-output module; and
the junction box device comprising a first processing unit, wherein the first processing unit is configured to:
receive, the first request from the field signal marshal device and the mixed signal from the signal mixer;
determine whether the specific unique ID matches with the at least one unique ID in the mixed signal; and
route the mixed signal associated with the at least one unique ID, to the first input-output channel based on a determination that the specific unique ID matches with the at least one unique ID.

2. The system according to claim 1, further comprising a memory configured to store a lookup table,
wherein the look-up table comprises information associated with a plurality of mappings between:
a plurality of unique IDs associated with a plurality of field devices connected to the industrial communication network, and
a plurality of input-output channels of the field signal marshal device, and
wherein the first processing unit is further configured to:
capture a signal from an active communication channel between a field device of the plurality of field devices and a second input-output channel of the plurality of input-output channels;
extract a unique ID from the signal captured from the active communication channel;
analyze the plurality of mappings in the look-up table to determine whether the extracted unique ID is mapped to the second input-output channel of the plurality of input-output channels; and
terminate the active communication channel based on a determination that the extracted unique ID is not mapped to the second input-output channel of the plurality of input-output channels.

3. The system according to claim 2, wherein the first processing unit is further configured to:
analyze the plurality of mappings of the look-up table to determine a third input-output channel of the plurality of input-output channels which is mapped to the extracted unique ID; and
reroute the captured signal to the determined third input-output channel of the plurality of input-output channels.

4. The system according to claim 3, wherein the field signal marshal device further comprises a second processing unit, wherein the second processing unit is configured to:
transmit a second request to the junction box device via the first input-output channel, wherein the second request is for a loop test of the first input-output channel;
determine whether the field signal marshal device receives a response for the second request from the junction box device, within a specified time interval, via the first input-output channel; and
display, based on a determination that the response is not received within the specific time interval, a notification that the first input-output channel is faulty; and
transmit the second request for the loop test to the junction box device via the second input-output channel of the plurality of input-output channels.

5. The system according to claim 4,
wherein the connector device further comprises a third processing unit which is configured to:
extract, from the look-up table, the at least one unique ID associated with the at least one field device; and
generate a high frequency signal based on the extracted at least one unique ID; and
wherein the at least one unique ID is superimposed on the at least one field signal by mixing the high frequency signal with the at least one field signal.

6. An apparatus for intelligent signal routing in an industrial communication network, the apparatus comprising:
a signal mixer configured to:
receive at least one field signal from the at least one field device, wherein the at least one field device has at least one unique identification number (ID);
superimpose the at least one unique ID on the received at least one field signal to generate a mixed signal;
a first input-output channel configured to:
transmit to the signal mixer, a first request comprising a specific unique ID associated with a specific field signal; and
transmit the mixed signal to an input-output module; and
a first processing unit configured to:
receive, the first request from the first input-output channel and the mixed signal from the signal mixer;
extract the at least one unique ID from the mixed signal;
determine whether the specific unique ID matches with the at least one unique ID associated with the at least one field device; and
route the mixed signal associated with the at least one unique ID, to the first input-output channel based on a determination that the specific unique ID matches with the at least one unique ID associated with the at least one field device.

7. The apparatus according to claim 6, further comprising a memory comprising a look-up table,
wherein the look-up table comprises information associated with mappings between:
a plurality of unique IDs associated with a plurality of field devices in the industrial communication network, and
a plurality of input-output channels of the field signal marshal device, and
wherein the first processing unit is further configured to:
capture a signal from an active communication channel between a field device of the plurality of field devices and a second input-output channel of the plurality of input-output channels;
extract a unique ID from the signal captured from the active communication channel;
analyze the look-up table to determine whether, in the look-up table, the extracted unique ID is mapped to the second input-output channel of the plurality of input-output channels; and
terminate the active communication channel based on a determination that the extracted unique ID is not mapped to the second input-output channel of the plurality of input-output channels.

8. The apparatus according to claim 7, wherein the first processing unit is further configured to:
analyze the look-up table to determine a third input-output channel of the plurality of input-output channels, into which the extracted unique ID is mapped; and
reroute the captured signal to the determined third input-output channel of the plurality of input-output channels.

9. The apparatus according to claim 8, further comprising a second processing unit, wherein the second processing unit is configured to:
transmit a second request to the first processing unit via the first input-output channel, wherein the second request is for conducting a loop test of the first input-output channel;
determine whether the first input-output channel receives a response for the second request from the first processing unit, within a specified time interval, via the first input-output channel; and
display, based on a determination that the response is not received within the specific time interval, a notification that the first input-output channel is faulty; and
transmit the second request for the loop test to the first processing unit via the second input-output channel.

10. The apparatus according to claim 9, further comprising a third processing unit which is configured to:
extract, from the look-up table, the at least one unique ID associated with the at least one field device; and
generate the high frequency signal based on the extracted at least one unique ID, wherein the at least one unique ID is superimposed on the at least one field signal by mixing the high frequency signal with the at least one field signal.

11. A method of intelligent signal routing in an industrial communication network, the method comprising:
in system comprising a signal mixer, a first input-output channel, and a first processing unit:
receiving, by the signal mixer, at least one field signal from the at least one field device, wherein the at least one field device has at least one unique identification number (ID);
superimposing, by the signal mixer, the at least one unique ID on the received at least one field signal to generate a mixed signal;
transmitting via the first input-output channel to a junction box device, a first request comprising a specific unique ID associated with a specific field signal;
extracting, by the first processing unit, the at least one unique ID from the mixed signal;
determining, by the first processing unit, whether the specific unique ID matches with the at least one unique ID associated with the at least one field device; and
routing, by the first processing unit, the mixed signal associated with the at least one unique ID, to the first input-output channel based on a determination that the specific unique ID matches with the at least one unique ID associated with the at least one field device.

12. The method according to claim 11, further comprising:
capturing, by the first processing unit, a signal from an active communication channel between a field device of a plurality of field devices and a second input-output channel of a plurality of input-output channels;
extracting, by the first processing unit, a unique ID from the signal captured from the active communication channel;
analyzing, by the first processing unit, a look-up table to determine whether, in the look-up table, the extracted unique ID is mapped to the second input-output channel of the plurality of input-output channels; and
terminating, by the first processing unit, the active communication channel based on a determination that the extracted unique ID is not mapped to the second input-output channel of the plurality of input-output channels.

13. The method according to claim 12, further comprising:
analyzing, by the first processing unit, the look-up table to determine a third input-output channel of the plurality of input-output channels, which is mapped to the extracted unique ID; and
rerouting, by the first processing unit, the captured signal to the determined third input-output channel of the plurality of input-output channels.

14. The method according to claim 13, further comprising:
transmitting, by the first processing unit, a second request to the junction box device via the first input-output channel, wherein the second request is for a loop test of the first input-output channel;
determining, by the first processing unit, whether the field signal marshal device receives a response for the second request from the junction box device, within a specified time interval, via the first input-output channel; and
displaying, by the first processing unit, based on a determination that the response is not received within the specific time interval, a notification that the first input-output channel is faulty; and
transmitting, by the first processing unit, the second request for the loop test to the junction box device via the second input-output channel.

15. The method according to claim 12, further comprising:
extracting, by the first processing unit, from the look-up table, the at least one unique ID associated with the at least one field device;
generating, by the first processing unit, the high frequency signal based on the extracted at least one unique ID, wherein the at least one unique ID is superimposed on the at least one field signal by mixing the high frequency signal with the at least one field signal.
